(19) United States
(12) Patent Application Publication
(10) Pub. No.: US 2024/0280921 A1
(43) Pub. Date: Aug. 22, 2024

(54) TWO-COMPONENT DEVELOPING AGENT, DEVELOPING AGENT ACCOMMODATING UNIT, IMAGE FORMING APPARATUS, AND IMAGE FORMING METHOD

(71) Applicants: Kohtaroh Ogino, Shizuoka (JP); Yoshitaka Yamauchi, Shizuoka (JP); Ayaka Mori, Shizuoka (JP)

(72) Inventors: Kohtaroh Ogino, Shizuoka (JP); Yoshitaka Yamauchi, Shizuoka (JP); Ayaka Mori, Shizuoka (JP)

(73) Assignee: Ricoh Company, Ltd., Tokyo (JP)

(21) Appl. No.: 18/439,850

(22) Filed: Feb. 13, 2024

(30) Foreign Application Priority Data
Feb. 17, 2023 (JP) 2023-023505

(51) Int. Cl. G03G 9/113; G03G 9/087

(52) U.S. Cl. CPC G03G 9/1139; G03G 9/08708; G03G 9/08755; G03G 9/1136; G03G 2215/0607

(57) ABSTRACT

A two-component developing agent contains a toner that contains a pulverized toner, the pulverized toner containing at least one type of polyester resin, a styrene-based resin or an aromatic petroleum resin, and Fisher-Tropsch wax, and a carrier that contains a silicone resin covering layer containing conductive fine powder.

### CROSS-REFERENCE TO RELATED APPLICATIONS

This patent application is based on and claims priority pursuant to 35 U.S.C. § 119 to Japanese Patent Application No. 2023-023505, filed on Feb. 17, 2023, in the Japan Patent Office, the entire disclosure of which is hereby incorporated by reference herein.

### BACKGROUND

### Technical Field

The present disclosure relates to a two-component developing agent, a developing agent accommodating unit, an image forming apparatus, and an image forming method.

### Description of the Related Art

In a conventional electronic photoconductor and electrostatic recording apparatus, the development process involves conveying a developing agent using a conveyance device followed by visualizing a latent electrostatic image formed on the photoconductor with the developing agent. Typically, this development method utilizes a one-component developing agent consisting solely of toner or a two-component developing agent containing both toner and a carrier.

A pulverized toner has been proposed in Unexamined Japanese Patent Application Publication No. 2021-144186 that contains highly pulverizable and good heat resistant styrene-based resin being exposed to the uppermost surface of the toner with a certain amount present inside the toner and encloses low heat resistant materials such as wax in an attempt to strike a balance between the low temperature fixability and high temperature storage stability. However, conventional two-component developing agents face an issue of toner adhesion to the carrier surface, known as toner spent. One critical problem arising from carrier degradation due to toner spent is reducing the carrier's charging ability. A decrease in the charging ability of the carrier causes toner scattering, leading to contamination inside an image forming apparatus and instability in image density.

### SUMMARY

According to embodiments of the present disclosure, a two-component developing agent is provided that contains a toner that contains a pulverized toner, the pulverized toner containing at least one type of polyester resin, a styrene-based resin or an aromatic petroleum resin, and Fisher-Tropsch wax, and a carrier that contains a silicone resin covering layer containing conductive fine powder.

As another aspect of embodiments of the present disclosure, a developing agent accommodating unit is provided that accommodates the two-component developing agent mentioned above.

As another aspect of embodiments of the present disclosure, an image forming apparatus is provided that includes a latent electrostatic image bearer, a charger for charging the latent electrostatic image bearer, an irradiator for irradiating the latent electrostatic image bearer with light to form a latent electrostatic image, a developing device for developing the latent electrostatic image formed on the latent electrostatic image bearer with the two-component developing agent mentioned above to form a toner image, a transfer device for transferring the toner image formed on the latent electrostatic image bearer onto a recording medium, and a fixing device for fixing the toner image transferred to the recording medium. As another aspect of embodiments of the present disclosure, an image forming method is provided that includes forming a latent electrostatic image on a latent electrostatic image bearer, developing the latent electrostatic image formed on the latent electrostatic image bearer with the two-component developing agent mentioned above to form a toner image, transferring the toner image formed on the latent electrostatic image bearer to a recording medium, and fixing the toner image transferred to the recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus according to an embodiment of the present invention; and

FIG. 2 is a schematic diagram illustrating an example of a process cartridge using an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present invention, a two-component developing agent is provided that lowers the occurrence of toner adhesion to the carrier surface known as toner spent and mitigates the decline in long-term charging.

The two-component developing agent of the present disclosure contains a toner containing a pulverized toner. The pulverized toner contains at least one type of polyester resin, a styrene-based resin or an aromatic petroleum resin, and Fisher-Tropsch wax, and a carrier containing a silicone resin covering layer comprising conductive fine powder.

The toner of the present disclosure is pulverized toner manufactured via a pulverization method.

In this process, the toner's constituents—binder resin, colorant, and wax—are melt-kneaded, cooled, then pulverized and classified.

One of the causes of toner spent on a carrier is attributable to the significant exposure of the wax component on the surface of the pulverized toner.

In the present disclosure, styrene-based resin or aromatic petroleum resin is used as a component of the toner's binder resin.

Styrene-based resin and aromatic petroleum resin exhibit excellent pulverizability. The pulverizable styrene-based or aromatic petroleum resin contained as a component is attributable to specific pulverization at the interface of these resins during the toner's pulverization process. As a result, the wax component is not readily exposed onto the pulverized surface.

### Styrene-Based Resin

The styrene-based resin has a styrene backbone and is a monopolymer or copolymer containing styrene or a styrene substitute.

The above-mentioned styrene-based resins are not particularly restricted, and can be suitably selected to suit to a particular application.

Specific examples include, but are not limited to, polystyrene, chloropolystyrene, poly-α-methylstyrene, styrene/chlorostyrene copolymer, styrene/propylene copolymer, styrene/butadiene copolymer, styrene/vinyl chloride copolymer, styrene/vinyl acetate copolymer, styrene/maleic acid copolymer, and styrene-α-methylstyrene copolymer. These can be used alone or in combination. Of these, styrene-α-methylstyrene copolymers are preferable.

Synthetic or procured styrene-based resins can be used as the styrene-based resin.

The procured styrene resin is not particularly limited and can be suitably selected to suit to a particular application. Specific examples include, but are not limited to, FTR-2140 (styrene α-methylstyrene copolymer, available from Mitsui Chemicals, Inc.) and SX100 (styrene resin, available from Yasuhara Chemical Co., Ltd.).

### Aromatic Petroleum Resin

The aromatic petroleum resin is a resin synthesized from petroleum C9 fractions such as styrene, vinyl toluene, and indene.

There are no particular restrictions on the aromatic petroleum resin, and it can be suitably selected to suit to a particular application. For example, M-135 (hydrogenated petroleum resin, available from Arakawa Chemical Industries, Ltd.) can be used as the aromatic petroleum resin.

The proportion of the styrene-based resin or aromatic petroleum resin is not particularly limited and can be suitably selected to suit to a particular application. The number of parts of the release agent is preferably from 1 to 16 parts by mass and more preferably from 2 to 15 parts by mass to 100 parts of the toner.

### Polyester Resin

The polyester resin is obtained via polycondensation reaction between a commonly known alcohol and a commonly known carboxylic acid.

Examples of the alcohol include, but are not limited to, diols, etherified bisphenols, dialcohol monomers obtained by substituting diols or etherified bisphenols with a saturated or unsaturated hydrocarbon group with 3 to 22 carbon atoms, and tri- or higher alcohol monomers.

Specific examples of the diol include, but are not limited to, ethylene glycol, polyethylene glycol, diethylene glycol, triethylene glycol, 1,2-propylene glycol, 1,3-propylene glycol, 1,4-propylene glycol, neopentyl glycol, and 1,4-butene diol.

Specific examples of the etherified bisphenol include, but are not limited to, 1,4-bis(hydroxymethyl)cyclohexane, bisphenol A, hydrogenated bisphenol A, polyoxyethylenated bisphenol A, polyoxypropylenated bisphenol A, bisphenol A propylene oxide, and bisphenol A ethylene oxide.

Specific examples of the trivalent or higher alcohol monomer include, but are not limited to, sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

These can be used alone or in combination.

Examples of the carboxylic acid include, but are not limited to, monocarboxylic acids, divalent organic acid monomers, their anhydrides, dimers of lower alkyl esters and linoleic acid, and trivalent or more polyvalent carboxylic acid monomers.

Specific examples of the monocarboxylic acid include, but are not limited to, palmitic acid, stearic acid, and oleic acid.

Specific examples of the divalent organic acid monomers include, but are not limited to, maleic acid, fumaric acid, mesaconic acid, citraconic acid, terephthalic acid, cyclohexanedicarboxylic acid, succinic acid, adipic acid, sebacic acid, malonic acid, and their substitutes substituted with a saturated or unsaturated hydrocarbon group having 3 to 22 carbon atoms.

Specific examples of the trivalent or higher polyvalent carboxylic acid monomers include, but are not limited to, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid (Empol®, trimer acid), and anhydrides of these acids.

These can be used alone or in combination.

The molecular weight of the polyester resin is from 3,500 to 5,500 and preferably from 4,000 to 4,500.

The molecular weight of the polyester resin can be obtained from the molecular weight distribution of the tetrahydrofuran (THF) soluble portion obtained by gel permeation chromatography (GPC). The calibration curve can be created using a reference polystyrene sample.

The proportion of the polyester resin to the toner is not particularly limited and can be suitably selected to suit to a particular application. It is preferably from 70 to 90 percent by mass and more preferably from 75 to 85 percent by mass to the mass of toner.

### Other Components

The other components are not particularly limited and can be suitably selected to suit to a particular application. Specific examples include, but are not limited to, colorants, resin fine particles, charge control agents, external additives, flow improvers, cleanability improvers, and magnetic materials.

### Colorant

The colorant for use in the toner of the present disclosure includes conventionally known dyes and pigments such as carbon black, lamp black, iron black, aniline blue, phthalocyanine blue, phthalocyanine green, hansa yellow G, rhodamin 6C lake, calco oil blue, chrome yellow, quinacridone, benzidine yellow, rose bengal, and triarylmethane dyes.

These can be used alone or in combination. They can be used as black toner or full color toner.

The proportion of the colorant to the binder resin component of a toner is preferably from 1 to 30 percent by mass and more preferably from 3 to 20 percent by mass.

### Charge Control Agent

There is no specific limitation to the selection of the charge control agent and it can be suitably selected to suit to a particular application.

Specific examples include, but are not limited to, nigrosine dyes, triphenylmethane dyes, chrome containing metal complexes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid and metal salts of salicylic acid derivatives.

Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are available from Orient Chemical Industries Co., Ltd.; TP-302 and TP-415 (molybdenum complex of quaternary ammonium salt) and azo iron compound T-77, which are available from Hodogaya Chemical Co., Ltd.; LRA-901, and LR-147 (boron complex), which are available from Japan Carlit Co., Ltd.; copper phthalocyanine, perylene, quinacridone, azo pigments and polymers having a functional group such as a sulfonate group, a carboxyl group, and a quaternary ammonium group.

### External Additive

The external additive is not particularly limited and can be suitably selected to suit to a particular application.

Specific examples include, but are not limited to, aliphatic acid metal salts such as zinc stearate and aluminum stearate; metal oxides such as titania, alumina, tin oxide, antimony oxide, and titanium oxide; silica; hydrophobic silica; and fluoropolymers. Of these, hydrophobic silica, alumina, titanium dioxide, and titania are preferable.

As the silica and titanium oxide, it is preferable to use hydrophobic silica and hydrophobic titanium obtained by surface-treating the silica and titanium oxide with a flow improver, which is described later.

Specific examples of the silica include, but are not limited to, R972, R974, RX200, RY200, R202, R805, and R812 (all available from Nippon Acrosil Co., Ltd.) and HDK-2000 (available from Clariant AG).

Specific examples of the titania include, but are not limited to, P-25 (available from NIPPON AEROSIL CO., LTD.), STT-30 and STT-65C-S (both available from TITAN KOGYO, LTD.), TAF-140 (available from FUJI TITANIUM INDUSTRY CO., LTD.), and MT-150W, MT-500B, MT-600B, and MT-150A (all available from TAYCA CORPORATION).

Specific examples of the titanium oxide include, but are not limited to, T-805 (available from NIPPON AEROSIL CO., LTD.); STT-30A and STT-65S-S (available from TITAN KOGYO, LTD.); TAF-500T and TAF-1500T (available from FUJI TITANIUM INDUSTRY CO., LTD.); MT-100S and MT-100T (available from TAYCA CORPORATION); and IT-S (available from ISHIHARA SANGYO KAISHA LTD.).

### Flow Improver

There is no particular limitation to the flow improver mentioned above and it can be suitably selected to suit to a particular application as long as it is surface-treated for enhancing hydrophobicity and can keep the fluidity and chargeability even in a highly humid environment. Specific examples include, but are not limited to, silane coupling agents, silylating agents, silane coupling agents including an alkyl fluoride group, organic titanate coupling agents, aluminum-containing coupling agents, silicone oil, and modified silicone oil.

### Carrier

The carrier includes a core material and a silicone resin covering layer that covers the core material.

### Core Material

The core material is not particularly limited and can be suitably selected to suit to a particular application. Examples of the core material include, but are not limited to, highly-magnetized materials such as 50 to 90 emu/g manganese-strontium-based materials, 50 to 90 emu/g manganese-magnesium-based materials, 100 or more emu/g iron powder, and 75 to 120 emu/g magnetite and low-magnetized materials such as 30 to 80 emu/g copper-zinc-based materials. Those defoaming agents can be used alone or in combination.

The volume average particle diameter of the core material is not particularly limited and can be suitably selected to suit to a particular application. For example, the core material preferably has a volume average particle diameter of from 10 to 150 μm and more preferably from 40 to 100 μm.

The silicone resin in the present disclosure represents all of the known silicone resins. Examples include, but are not limited to, straight silicone resins formed of organosiloxane bonding alone and silicone resins modified with a functional group such as alkyd, polyester, epoxy, acrylic, and urethane.

The silicone resins are commercially available.

Specific examples of the straight silicone resin include, but are not limited to, KR271, KR255, and KR152, available from Shin-Etsu Chemical Co., Ltd.; and SR2400, SR2406, and SR2410, available from DOW CORNING TORAY CO., LTD. In this case, it is possible to use silicone resin alone, but it is also possible to use other components for cross-linking reactions or charge control simultaneously.

Specific examples of the procurable modified silicone resins include, but are not limited to, KR206 (alkyd-modified), KR5208 (acrylic-modified), ES1001N (epoxy-modified), and KR305 (urethane-modified), all available from Shin-Etsu Chemical Co., Ltd. and SR2115 (epoxy-modified) and SR2110 (alkyd-modified), both available from DOW CORNING TORAY CO., LTD.

### Conductive Fine Powder

Specific examples of conductive fine powder include, but are not limited to, carbon black, indium-doped tin oxide, tungsten-doped tin oxide, phosphorus-doped tin oxide, niobium, tantalum, and antimony pentoxide-doped tin oxide.

The content of the conductive fine particles is preferably from 30 to 50 parts by mass and more preferably from 35 to 45 parts by mass to 100 parts by mass of the silicone resin.

### Other Optional Components

The other optional components are not particularly limited and can be suitably selected to suit to a particular application. They include, but are not limited to, silane coupling agents and inorganic particles.

### Silane-Coupling Agent

The silane coupling agent is not particularly limited and can be suitably selected to suit to a particular application.

Specific examples include, but are not limited to, methyltrimethoxysilane, methyltriethoxysilane, vinyltriacetoxysilane, γ-chloropropyltrimethoxysilane, hexamethyldisilazane, γ-aminopropyltrimethoxysilane, vinyltrimethoxysilane, octadecyldimethyl[3-(trimethoxysilyl)propyl]ammonium chloride, γ-chloropropylmethyldimethoxysilane, methyltrichlorosilane, dimethyldichlorosilane, trimethylchlorosilane, allyltriethoxysilane, 3-aminopropylmethyldiethoxysilane, 3-aminopropyltrimethoxysilane, aminoethyl aminopropyl trimethoxysilane, dimethyldiethoxysilane, 1,3-divinyltetramethyldisilazane, and methacryloxyethyl dimethyl(3-trimethoxysilylpropyl)ammonium chloride.

Of these, as a silane coupling agent, amino silane coupling agents are preferable, and, of the amino silane coupling agents, aminoethyl aminopropyl trimethoxysilane is preferable.

These can be used alone or in combination.

Such silane coupling agents can be procured. Specific examples of the procurable products include, but are not limited to, AY43-059, SR6020, SZ-6023, SH6020, SH6026, SZ6032, SZ6050, AY43-310M, SZ6030, SH6040, AY43-026, AY43-031, sh6062, Z-6911, sz6300, sz6075, sz6079, sz6083, sz6070, sz6072, Z-6721, AY43-004, Z-6187, AY43-021, AY43-043, AY43-040, AY43-047, Z-6265, AY43-204M, AY43-048, Z-6403, AY43-206M, AY43-206E, Z6341, AY43-210MC, AY43-083, AY43-101, AY43-013, AY43-158E, Z-6920, and Z-6940 (all available from Dow Corning Toray Co., Ltd.).

The proportion of the silane coupling agent to a silicone resin is preferably from 0.1 to 10 percent by mass.

In the present disclosure, the carrier includes the carrier core material coated with a resin coating layer containing conductive fine powder on its surface.

The application of silicone resin onto the carrier core material surface can reduce toner adhesion to a carrier, known as toner spent. To optimize this effect, complete coverage of the carrier surface with silicone resin is preferred.

However, this increased silicone resin coverage also elevates the carrier's resistance, which necessitates the inclusion of conductive fine particles within the silicone resin coating layer for adjustment.

This toner-carrier configuration minimizes wax exposure on the toner surface, resulting in the reduction of toner spent, along with carrier spent. Consequently, this approach minimizes adverse effects on long-term chargeability.

Moreover, the toner of the present disclosure uses Fischer-Tropsch wax as a release agent.

Fischer-Tropsch wax is a straight-chain hydrocarbon compound with few iso structural molecules or side chains, produced via the catalytic hydrogeneation of carbon monoxide, known as Fischer-Tropsch reaction.

Preferably, Fischer-Tropsch wax like FNP-0090 (melting point: 90 degrees C.) from NIPPON SEIRO CO., LTD. is used.

While there is no specific limit on the quantity of Fischer-Tropsch wax added, it is preferable that the waxes range from 1 to 5 percent by mass of the toner's total mass.

### Developing Agent Accommodating Unit

The developing agent accommodating unit in the present disclosure contains a developing agent and a container containing the developing agent.

Embodiments of the developing agent accommodating unit include a container with a developing agent, a developing unit, and a process cartridge.

The container with a developing agent means a container containing a developing agent.

The developing unit accommodates a developing agent and develops with it.

The process cartridge integrally includes at least an image bearer and a developing device, detachably attachable to an image forming apparatus. The process cartridge may integrate at least one of a charger, an irradiator, and a cleaner with an image bearer and a developing device.

### Image Forming Apparatus

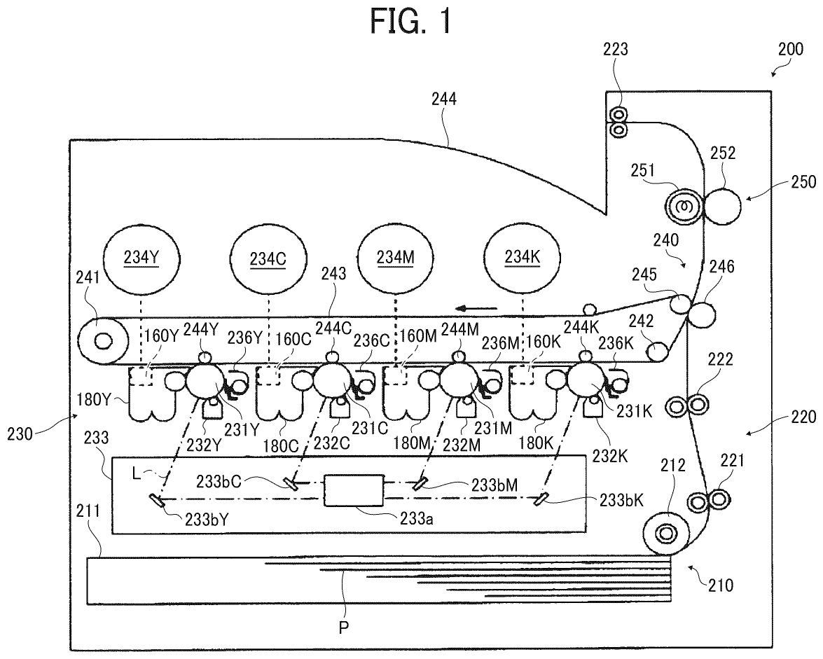

Next, an embodiment of image forming with the image forming apparatus of the present disclosure is described with reference to FIG. 1. One of the image forming apparatuses in the present embodiment is a printer. However, the image forming apparatus is not particularly limited to an apparatus such as a printer, a photocopier, a facsimile machine, or a multifunction peripheral as long as it can form images with toner.

An image forming apparatus 200 includes a sheet feeding unit 210, a conveyance unit 220, an image forming unit (latent electrostatic image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer unit 240, a pair of timing rollers 222 for pinching the front end of the sheet P conveyed by the roller 221 on standby and sending out the sheet P to the transfer unit 240 at a particular timing, and ejection rollers 223 for ejecting the sheet P on which toner is fixed by the fixing unit 250 to an ejection tray 224.

The image forming unit 230 includes an image forming unit (latent electrostatic image bearer) 234Y that forms an image using a developing agent containing yellow toner, an image forming unit 234C that forms an image using a developing agent containing cyan toner, an image forming unit 234M that forms an image using a developing agent containing magenta toner, and an image forming unit 234K that forms an image using a developing agent containing black toner, sequentially standing from left to right in the drawing with a particular interval. The image forming unit 230 also includes a charger 232 (232Y, 232M. 232C. 232K) and an irradiator 233 that emits beams of light L. The irradiator 233 includes a light source 233a and a polygon mirror 233b (233bY, 233bM, 233bC, 233bK) that redirects the beams of light L to the charger 232.

An arbitrary image forming unit of the image forming units 234Y, 234C, 234M, and 234K is referred to as an image forming unit.

In addition, the developing agent contains toner and carrier. The four image forming units have substantially the same structure except for the individual developing agents used for respective image forming units.

The transfer unit 240 includes a driving roller 241, a driven roller 242, an intermediate transfer belt 243 disposed rotatable counterclockwise in the drawing in accordance with the drive of the driving roller 241, a primary transfer roller (244Y, 244C, 244M, and 244K) disposed facing the drum photoconductor (latent electrostatic image bearer) 231 with the intermediate transfer belt 243 therebetween, and a secondary facing roller 245 and a secondary transfer roller 246 disposed facing each other at the point of the toner image transferred to the sheet P with the intermediate transfer belt 243 therebetween.

A fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

### Process Cartridge

The process cartridge relating to the present disclosure is made to be detachably attachable to an image forming apparatus. It includes at least a latent electrostatic image bearer and a developing device that renders the latent electrostatic image visible with a developing agent containing the toner of the present disclosure to form a toner image. The process cartridge may furthermore include other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

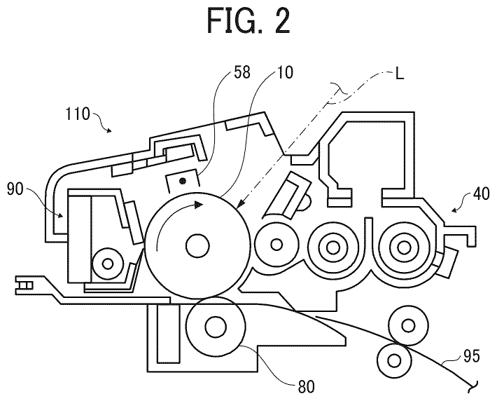

FIG. 2 is a diagram illustrating an example of the process cartridge relating to the present disclosure. The process cartridge 110 includes a drum photoconductor (latent electrostatic image bearer) 10, a corona charger 58, a developing device 40, a transfer roller 80, and a cleaner 90.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. “Parts” represents parts by mass and “percent” represents percent by mass unless otherwise specified in the following description.

### Synthesis of Amorphous Polyester Resin 1

In a reaction vessel equipped with a cooling tube, a stirrer, and a nitrogen introduction tube, the monomers shown in Table 1 and tetra-n-butoxytitanate as a condensation catalyst were loaded and were allowed to react at 230 degrees C. for 6 hours under a nitrogen gas flow while removing the generated water. Subsequently, under a reduced pressure of 5 mmHg to 20 mmHg, Amorphous Polyester Resin 1 to be used in Examples was obtained after a 1-hour reaction. In Table 1, “25 percent by mol” indicated for bisphenol A (2,2) propylene oxide represents the proportion of the alcohol component when the acid component is 50 percent by mol and the alcohol component is 50 percent by mol.

TABLE 1

| Acid component | Alcohol component | OH/COOH |
|---|---|---|
| Terephthalic acid | Bisphenol A (2,2) | 1:1 |
| | Propylene oxide (25 percent | |
| | by mol) | |
| | Bisphenol A (2,2) | |
| | Ethylene oxide (25 percent | |
| | by mol) | |

### Example 1

### Preparation of Toner 1

### Prescription of Mother Toner Particle 1

Amorphous polyester resin 1: 75 parts
Fisher-Tropsch wax (FNP-0090, available from NIPPON SEIRO CO., LTD.: 6 parts
Styrene-based resin (FTR-2140, available from Mitsui Chemicals, Inc.): 7 parts
Colorant (carbon black #44, available from Mitsubishi Chemical Corporation): 11 parts
Charge control agent (T-77, available from HODOGAYA CHEMICAL CO., LTD.): 1 part

The toner materials prescribed as above were preliminarily mixed with a HENSCHEL MIXER (FM20B, available from NIPPON COKE & ENGINEERING CO., LTD.) and thereafter, melt-kneaded at 120 degrees C. with a twin-shaft kneader (PCM-30, available from Ikegai Corporation).

The resulting melt-kneaded product was rolled to a thickness of 2.7 mm, cooled to room temperature with a belt cooler, and coarsely pulverized with a hammer mill to 200 to 300 μm.

Next, the coarsely pulverized matter was finely pulverized with a supersonic pulverizer (LABO JET, available from Nippon Pneumatic Mfg. Co., Ltd.). The finely-pulverized matter was then classified with an air-stream classifier (MDS-I, available from Nippon Pneumatic Mfg. Co., Ltd.) while adjusting the aperture of the louver to obtain Mother Toner Particle 1 with a weight average particle diameter of 5.8±0.2 μm.

### External Additive Treatment

One part of an external additive, HDK-2000, available from Clariant AG, was added to 100 parts of Mother Toner Particle 1, followed by stirring with a Henschel Mixer to obtain externally added Mother Toner Particle 1, i.e., Toner 1.

### Preparation of Carrier 1

A total of 200 parts of silicone resin solution RSR213, available from Dow Corning Toray Co., Ltd. 3 parts of carbon black (BP-2000, available from Cabot Corporation), and 0.8 parts of aminoethyl aminopropyl trimethoxysilane (SH6020, available from Dow Corning Toray Co., Ltd.) were dissolved or dispersed in toluene to prepare a liquid application.

Using SPIRA COTAR, available from OKADA SEIKO CO., LTD., the liquid application was applied to 2,500 parts of powdered ferrite, DFC-400M (Mn ferrite, available from DOWA IP Creation Co., Ltd.), followed by baking with an electric furnace at 300 degrees C. for two hours to obtain Carrier 1.

### Preparation of Two Component Developing Agent 1

A total of 93 parts of Toner 1 was mixed with 7 parts of Carrier 1 using a Turblar Mixer T2C type (available from Shinmaru Enterprises Corporation) at 32 rotation per minute (rpm) for 7 minutes to obtain Two Component Development Agent 1.

### Examples 2 to 6 and Comparative Examples 1 to 3

### Preparation of Toner 2 to Toner 9

Mother Toner Particles 2 to 9 were prepared in the same manner as in the preparation of Mother Toner Particle 1 except that the type and content of the resin and the type of the wax were changed as shown in the prescriptions shown in Table 2.

Mother Toner Particles 2 to 9 were then subjected to the external additive treatment in the same manner as in Preparation of Toner 1 to obtain Toner 2 to Toner 9.

The prescriptions of Toner 1 to Toner 9 are shown in Table 2.

The products shown in Table 2 are as follows.
Hydrogenated petroleum resin, M-135, available from Arakawa Chemical Industries, Ltd.

### Preparation of Two Component Developing Agent 2 to Two Component Developing Agent 8

Two Component Developing Agent 1 to Two Component Developing Agent 8 were prepared in the same manner as in Preparation of Two Component Developing Agent 1 except that Toner 1 was replaced with Toner 2 to Toner 8.

### Preparation of Two Component Developing Agent

Two Component Developing Agent 9 was prepared in the same manner as in Preparation of Two Component Developing Agent 1 except that Carrier 1 was replaced with Carrier 2.

### Preparation of Carrier 2

A total of 200 parts of silicone resin solution RSR213, available from Dow Corning Toray Co., Ltd., was dissolved or dispersed in toluene to prepare a liquid application.

Using SPIRA COTA®, available from OKADA SEIKO CO., LTD., the liquid application was applied to 2,500 parts of powdered ferrite, DFC-400M (Mn ferrite, available from DOWA IP Creation Co., Ltd.), followed by baking with an electric furnace at 300 degrees C. for two hours to obtain Carrier 2.

### Evaluation on Long-Term Charging Stability

Long-term charging stability was evaluated according to the following evaluation method using Two Component Developing Agent 1 to Two Component Developing Agent 9.

### Evaluation Method

The electrostatic charge at the point of feeding 10,000 sheets using a digital full-color printer imagio MP C5000 (available from Ricoh Co., Ltd.) was measured using the blow-off static charge measuring device (TB-200, available from Toshiba Chemicals Co., Ltd.).

Then the electrostatic charge at the point of feeding 50,000 sheets was measured using the blow-off static charge measuring device.

The value obtained from the following relationship was determined as the index of charging stability.

Index of charging stability (percent)=[Electrostatic charge at the point of feeding 50,000 sheets/Electrostatic charge at the point of feeding 10,000 sheets]×100

The index values of charging stability were graded according to the evaluation criteria below.

### Evaluation Criteria

S: 90 or more percent
A: 70 percent to less than 90 percent
C: Less than 70 percent

The evaluation results are shown in Table 2.

TABLE 2

| | Toner | | | | |
|---|---|---|---|---|---|
| | | Styrene- | | | |
| | | based | | | |
| | | resin or | | | |
| | | aromatic | | | |
| | | petroleum | | | |
| Example/ | | resin | | Amorphous | |
| Comparative | Toner | Type of | Number | polyester | |
| Example No. | No. | resin | of parts | resin | Wax |
| Example 1 | Toner | FTR- | 7 | Amorphous | FNP- |
| | 1 | 2140 | | polyester | 0090 |
| Example 2 | Toner | FTR- | 15 | resin 1 | FNP- |
| | 2 | 2140 | | | 0090 |
| Example 3 | Toner | FTR- | 16 | | FNP- |
| | 3 | 2140 | | | 0090 |
| Example 4 | Toner | FTR- | 2 | | FNP- |
| | 4 | 2140 | | | 0090 |
| Example 5 | Toner | FTR- | 1 | | FNP- |
| | 5 | 2140 | | | 0090 |
| Example 6 | Toner | M-135 | 7 | | FNP- |
| | 6 | | | | 0090 |
| Comparative | Toner | — | 0 | | FNP- |
| Example 1 | 7 | | | | 0090 |
| Comparative | Toner | FTR- | 7 | | Carnauba |
| Example 2 | 8 | 2140 | | | wax |
| Comparative | Toner | FTR- | 7 | | FNP- |
| Example 3 | 9 | 2140 | | | 0090 |

| | Carrier | | Evaluation |
|---|---|---|---|
| Example/ | | Conductive | on long- |
| Comparative | Covering | fine | term |
| Example No. | resin | powder | stability |
| Example 1 | Silicone | BP-2000 | S |
| Example 2 | resin | BP-2000 | S |
| Example 3 | | BP-2000 | A |
| Example 4 | | BP-2000 | S |
| Example 5 | | BP-2000 | A |
| Example 6 | | BP-2000 | A |
| Comparative | | BP-2000 | C |
| Example 1 | | | |
| Comparative | | BP-2000 | C |
| Example 2 | | | |
| Comparative | | None | C |
| Example 3 | | | |

Aspects of the present disclosure include, but are not limited to the following:

Aspect 1: A two-component developing agent contains a toner containing a pulverized toner, the pulverized toner containing at least one type of polyester resin, a styrene-based resin or an aromatic petroleum resin, and Fisher-Tropsch wax; and a carrier containing a silicone resin covering layer containing conductive fine powder.

Aspect 2: The two-component developing agent according to Aspect 1, wherein the styrene-based resin comprises styrene-α-methylstyrene copolymer.

Aspect 3: The two-component developing agent according to Aspect 1 or 2, wherein the proportion of the styrene-based resin or the aromatic petroleum resin is from 2 to 15 parts by mass to 100 parts by mass of the toner.

Aspect 4: The two-component developing agent according to any one of Aspects 1 to 3, wherein the conductive fine powder contains carbon black and the silicone resin covering layer comprises an amino silane coupling agent.

Aspect 5: The two-component developing agent according to Aspect 4, the amino silane coupling agent contains aminoethyl aminopropyl trimethoxysilane.

Aspect 6: A developing agent accommodating unit accommodating the two-component developing agent of any one of Aspects 1 to 6.

Aspect 7: An image forming apparatus includes a latent electrostatic image bearer, a charger for charging the latent electrostatic image bearer, an irradiator for irradiating the latent electrostatic image bearer with light to form a latent electrostatic image, a developing device for developing the latent electrostatic image formed on the latent electrostatic image bearer with the two-component developing agent of any one of Aspects 1 to 5 to form a toner image, a transfer device for transferring the toner image formed on the latent electrostatic image bearer onto a recording medium, and a fixing device for fixing the toner image transferred to the recording medium.

Aspect 8: An image forming method includes forming a latent electrostatic image on a latent electrostatic image bearer, developing the latent electrostatic image formed on the latent electrostatic image bearer with the two-component developing agent of any one of Aspects 1 to 5 to form a toner image, transferring the toner image formed on the latent electrostatic image bearer to a recording medium, and fixing the toner image transferred to the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A two-component developing agent comprising:
a toner comprising a pulverized toner, the pulverized toner comprising:
at least one type of polyester resin;
a styrene-based resin or an aromatic petroleum resin; and
Fisher-Tropsch wax; and
a carrier comprising:
a silicone resin covering layer comprising conductive fine powder.

2. The two-component developing agent according to claim 1,
wherein the styrene-based resin comprises styrene-α-methylstyrene copolymer.

3. The two-component developing agent according to claim 1,
wherein a proportion of the styrene-based resin or the aromatic petroleum resin is from 2 to 15 parts by mass to 100 parts by mass of the toner.

4. The two-component developing agent according to claim 1,
wherein the conductive fine powder comprises carbon black and the silicone resin covering layer comprises an amino silane coupling agent.

5. The two-component developing agent according to claim 4,
wherein the amino silane coupling agent comprises aminoethyl aminopropyl trimethoxysilane.

6. A developing agent accommodating unit accommodating the two-component developing agent of claim 1.

7. An image forming apparatus comprising:
a latent electrostatic image bearer;
a charger to charge the latent electrostatic image bearer;
an irradiator to irradiate the latent electrostatic image bearer with light to form a latent electrostatic image;
a developing device to develop the latent electrostatic image formed on the latent electrostatic image bearer with the two-component developing agent of claim 1 to form a toner image;
a transfer device to transfer the toner image formed on the latent electrostatic image bearer onto a recording medium; and
a fixing device to fix the toner image transferred to the recording medium.

8. An image forming method comprising:
forming a latent electrostatic image on a latent electrostatic image bearer;
developing the latent electrostatic image formed on the latent electrostatic image bearer with the two-component developing agent of claim 1 to form a toner image;
transferring the toner image formed on the latent electrostatic image bearer to a recording medium; and
fixing the toner image transferred to the recording medium.
